(19) United States
(12) Patent Application Publication
(10) Pub. No.: US 2025/0129298 A1
(43) Pub. Date: Apr. 24, 2025

(54) PROCESS FOR PURIFYING A SYNTHETIC CRUDE OIL STREAM

(71) Applicant: OMV DOWNSTREAM GMBH, Wien (AT)

(72) Inventor: Matthias MASTALIR, Wien (AT)

(21) Appl. No.: 18/692,915

(22) PCT Filed: Sep. 16, 2022
(86) PCT No.: PCT/EP2022/075716

§ 371 Date: Mar. 18, 2024

(30) Foreign Application Priority Data
Sep. 17, 2021 (EP) 21197394.6

(51) Int. Cl. C10G 17/09; C08J 11/04

(52) U.S. Cl. CPC C10G 17/09; C08J 11/04; C10G 2300/1003

(57) ABSTRACT

A process for purifying a synthetic crude oil stream includes providing a synthetic crude oil stream, washing the synthetic crude oil stream with a first aqueous washing solution at a first temperature in order to obtain a first purified synthetic crude oil stream, and washing the first purified synthetic crude oil stream with a second aqueous washing solution at a second temperature in order to obtain a second purified synthetic crude oil stream. The first aqueous washing solution is basic, the second aqueous washing solution is acidic, and the second temperature is lower than the first temperature. A process for producing synthetic crude oil includes producing a synthetic crude oil stream, preferably by depolymerization of plastic material, in particular plastic waste, and purifying the synthetic crude oil stream.

The present invention relates to processes for purifying a synthetic crude oil stream.

Synthetic crude oil, sometimes also referred to as syncrude, can be obtained from different processes. For example, synthetic crude oil can be shale oil obtained from oil shale by pyrolysis. Another source is hydrocarbons obtained from oil sand, in particular bitumen, from which synthetic crude oil can be obtained by upgrading. In addition, synthetic crude oil can also be produced from plastic material, for example plastic waste, by cracking.

Synthetic crude oils typically contain different impurities, which can have adverse effects on refining processes and refinery plants or make the crude oil completely unsuitable for certain refining processes. The type and content of the impurities can vary greatly depending on the source and process for obtaining the synthetic crude oil.

WO 2020/020769 A1 describes processes for purifying a recycled or renewable organic material, comprising heating the material in the presence of an aqueous alkali metal hydroxide solution and hydrotreating in the presence of a hydrotreating catalyst to obtain purified material with a reduced chlorine content.

WO 2021/105326 A1 describes processes for the treatment of liquefied plastic waste material, comprising the pre-treatment of the liquefied plastic waste material with an aqueous medium having a pH value of at least 7 at a temperature of at least 200° C., subsequent hydrotreating and post-treatment in order to obtain a steam cracker feed.

WO 2014/165859 A1 describes processes and devices for treating synthetic crude oil, wherein the synthetic crude oil is washed with an aqueous basic process solution in order to reduce the acidity level. The process may also comprise two or more washing steps.

Further processes for purifying or treating oils are described in U.S. Pat. No. 9,045,698 B2, US 2006/144761 A1 and GB 590 635 A.

However, the purification processes known from the state of the art are often complex and/or inadequate. In particular, impurities, e.g. neutral compounds (such as esters, aldehydes, ketones, organohalogen compounds, amides, nitriles) or polycyclic amines are often removed inadequately or not at all. This is particularly problematic in the case of complex starting materials in which the impurity profiles can vary greatly, for example in the case of synthetic crude oil obtained from plastic waste. Inadequately removed impurities can subsequently lead to problems in the further processing of the purified crude oil. Another problem is the formation of sediments in the plants observed during many purification processes, which makes cleaning the plants more difficult and hinders efficient operation.

Therefore, there is still a need for new or improved processes for the purification of synthetic crude oil. It is an object of the present invention to provide such processes. In particular, it is an object of the invention to provide processes for purifying synthetic crude oil that enable particularly efficient and thorough removal of impurities, in particular not only impurities in the form of acidic or basic compounds, but also neutral compounds. Another object of the invention is to minimise the formation of sediments in the course of the purification process. Another object is to provide purification processes that are as efficient and economical as possible.

According to the invention, this object is achieved by a process for purifying a synthetic crude oil stream, comprising the following steps:
providing a synthetic crude oil stream;
washing the synthetic crude oil stream with a first aqueous washing solution at a first temperature in order to obtain a first purified synthetic crude oil stream; and
washing the first purified synthetic crude oil stream with a second aqueous washing solution at a second temperature in order to obtain a second purified synthetic crude oil stream, wherein the first aqueous washing solution is basic, the second aqueous washing solution is acidic, and the second temperature is lower than the first temperature.

In a further aspect, the present invention relates to a process for producing synthetic crude oil, comprising the following steps:
producing a synthetic crude oil stream, preferably by depolymerisation of plastic material, in particular plastic waste; and
purifying the synthetic crude oil stream according to the process for purifying a synthetic crude oil stream according to the invention.

In the course of the present invention, it has surprisingly resulted to be advantageous to carry out a basic washing step at a higher temperature followed by an acidic washing step at a lower temperature. Surprising advantages result both from the fact that the basic washing step is carried out before the acidic washing step and from the fact that the temperature in the basic washing step is higher than in the acidic washing step.

With regard to the sequence of the washing steps, it has surprisingly been found that carrying out the basic washing step before the acidic washing step can lead to better phase separation as well as a considerable reduction of sediments. When carrying out an acidic washing step without a previous basic washing step, the inventors observed the formation of sediments, which turned out to be mainly precipitated wax carboxylic acids. Wax carboxylic acids are long-chain carboxylic acids, for example with chain lengths between 20 and 75 carbon atoms. In addition to paraffinic unbranched and branched chains, wax carboxylic acids may also have aromatic, olefinic and heteroatomic functionalities. Wax carboxylic acids are contained in many synthetic crude oils, in particular in pyrolysis oils (e.g. from the pyrolysis of plastic), since these compounds can be increasingly formed in the pyrolysis process, e.g. from reactions with introduced oxygen or by already existing functional polymers or additives. In synthetic crude oil, wax carboxylic acids are often present in bound form as salts. In the course of the invention, it has been found that the treatment of an unpre-treated synthetic crude oil stream with an acidic aqueous washing solution can lead to bound wax carboxylic acids being protonated and thus released. The wax carboxylic acids released in this way can, on the one hand, precipitate and form unwanted sediments, and on the other hand, it has been shown that the released wax carboxylic acids can act as surfactants and form mixed phases or can bind unwanted compounds such as water, heavy metals and nitrogen compounds in the oil phase. Unremoved wax carboxylic acids can also lead to corrosion in the plants and act as a catalyst poison in subsequent further processing of the synthetic crude oil.

In the course of the invention, it has been found that the release of bound wax carboxylic acids and the associated problems can be reduced by carrying out a basic washing step before the acidic washing step. When washing with a basic aqueous washing solution, the wax carboxylic acids are mainly present in deprotonated state and can be removed via the aqueous phase, so that the adverse effects in the subsequent acidic washing step are reduced. The sequence provided according to the invention of washing with the first aqueous washing solution and the second aqueous washing solution can thus lead to a reduction in sediments in the plants, a better phase separation and thus a better removal of impurities, a reduction in corrosion in the plants and a protection of catalysts during further processing.

It has further been shown that it is advantageous for the removal of wax carboxylic acids to carry out the basic washing step at a high temperature. A high temperature leads to a better solubility of the wax carboxylic acids in the aqueous phase. It is therefore advantageous if the washing of the synthetic crude oil stream with the first aqueous washing solution is performed at a temperature of more than 70° C. It has proven to be particularly advantageous if the temperature is more than 95° C., since many salts of wax carboxylic acids, in particular alkali salts, are particularly well soluble in water at these temperatures and can be removed particularly efficiently via the aqueous phase.

In the state of the art, aqueous basic washing solutions have so far mainly been used to reduce the acid level in synthetic crude oil. In the course of the present invention, it has been found that an aqueous basic washing solution can even be used to remove neutral compounds such as esters, aldehydes, ketones, organohalogen compounds, amides and nitriles. In the process according to the invention, such neutral compounds can be hydrolysed by the first aqueous washing solution. The products of basic hydrolysis include acidic compounds, for example carboxylic acids, which are removed in the course of basic washing, as well as basic compounds, for example amines, which can be removed in the subsequent acidic washing step.

This results in a further advantage if the basic washing step is carried out at a higher temperature: While acidic compounds such as carboxylic acids and phenols only have to be deprotonated during basic washing in order to be removed with the aqueous washing solution, neutral compounds that cannot be deprotonated under the washing conditions must undergo a hydrolysis reaction. The hydrolysis reaction is temperature-dependent and proceeds faster at higher temperatures. Higher temperatures in the basic washing step therefore lead to better removal of neutral compounds. In this context, it is favourable if the washing of the synthetic crude oil stream with the first aqueous washing solution is performed at a temperature of more than 70° C. Even higher temperatures, for example more than 95° C., in particular more than 100° C., have proven to be particularly suitable for removing neutral compounds.

In addition to removing hydrolysis products from the basic washing step, the washing of the first purified synthetic crude oil stream with an acidic washing solution provided in the process according to the invention enables the removal of further basic compounds such as amines, pyridines and other basic impurities. As a result, in particular polycyclic amines can also be removed efficiently. Polycyclic amines can be present to a greater extent in synthetic crude oils, in particular in pyrolysis oils. They can form, for example, in cracking processes in the presence of a nitrogen source, for example additives or polymers such as polyamide (PA), polyacrylonitrile (PAN) or acrylonitrile-butadiene-styrene copolymer (ABS). In the case of polycyclic amines, they may be, for example, polycondensed-saturated, mono-and polyunsaturated or aromatic ring systems. They can be partially dissolved in the synthetic crude oil or suspended in the colloidal region and often result in undesirable sediments and thus in more difficult cleaning of the plant. In addition, they can lead to a blocking of active surfaces of catalysts in subsequent applications. In addition, they can dissolve undesirable compounds such as salts, chloride, heavy metals or sulphides in the organic product phase. It has been found that polycyclic amines can be efficiently removed by the process according to the invention. For the removal of polycyclic amines, it has proven advantageous if the acidic washing step is performed at a temperature of at least 20° C. The removal is particularly efficient if the temperature is at least 50° C.

However, in the course of the invention, it has surprisingly proven advantageous if the temperature in the acidic washing step is not too high, in particular lower than the temperature in the basic washing step. Thus, it has been found that high temperatures in the acidic washing step can lead to a reduction in the product yield as well as to the formation of impurities. In the opinion of the inventors, without being bound to a theory, this can be explained by reactions of olefins with the acid used, for example by hydroxy sulphonation or sulphation with sulphuric acid or by reactions with other acids. Alcohols, sulphonates, sulphates and hydroxy sulphonates can form as impurities, which can lead to sediments and thus more difficult cleaning and corrosion. It has therefore proven advantageous to carry out the acidic washing step at a temperature of less than 120° C. In particular, these adverse effects can be minimised if the temperature is less than 100° C., even more preferably less than 95° C.

An additional advantage of the lower temperature in the acidic washing step is that the requirements for the material of the washing device are significantly lower. The presence of acidic solutions at high temperatures often requires the use of special materials or coatings, which would lead to a significant increase in costs.

A further advantage of the sequence of washing steps in the process according to the invention, in particular in connection with preferred embodiments in which the basic and acidic washing steps are part of a continuous process, is that the process can be carried out particularly economically. Synthetic crude oil is usually obtained from processes with high temperatures, e.g. pyrolysis or cracking. If the production process according to the invention is downstream of such a process, no heating of the synthetic crude oil stream is required, provided that the basic washing step is carried out before the acidic washing step. The synthetic crude oil stream obtained from the production process can be washed with the first aqueous washing solution directly or after cooling to the first temperature, and the first purified synthetic crude oil stream obtained therefrom can be washed with the second aqueous washing solution after further cooling to the second temperature. Due to the fact that the synthetic crude oil stream does not have to be heated between the washing steps, the process can be carried out particularly economically and efficiently. In connection with the process according to the invention, it is therefore particularly preferred if the synthetic crude oil stream is not heated between washing at the first temperature and washing at the second temperature.

In a preferred embodiment of the process according to the invention, the first temperature is more than 70° C., preferably more than 80° C., more preferably more than 90° C., even more preferably more than 95° C., even more preferably more than 100° C., even more preferably more than 105° C., even more preferably more than 110° C., even more preferably more than 115°° C., even more preferably more than 120° C., even more preferably more than 125° C., even more preferably more than 130° C., most preferably more than 135° C. Providing such a high first temperature has the advantage that wax carboxylic acids present in the synthetic crude oil stream can dissolve better and can be removed by the basic washing. An additional advantage of the high first temperature is that basic hydrolysis reactions proceed particularly quickly and neutral compounds can thus be removed particularly well. It is particularly preferred if the first temperature is in the range from 70° C. to 190° C., preferably from 80° C. to 180° C., more preferably from 90° C. to 170° C., even more preferably from 95° C. to 165° C., even more preferably from 100° C. to 160° C., even more preferably from 105° C. to 155° C., even more preferably from 110° C. to 150° C., most preferably from 115° C. to 145° C.

In a preferred embodiment of the process according to the invention, the second temperature is less than 120° C., preferably less than 110° C., more preferably less than 100° C., even more preferably less than 95° C., even more preferably less than 90° C., even more preferably less than 80° C., most preferably less than 75° C. Providing such a lower temperature has the advantage that the formation of impurities can be reduced and the product yield can be increased. An additional advantage of the lower temperature is that the washing device is exposed to less harsh conditions and therefore requires less expensive materials or material coatings. At the same time, basic compounds such as amines and pyridines can still be efficiently removed, since only a protonation but, in contrast to neutral compounds, no hydrolysis reaction is required to remove these compounds. It is particularly preferred if the second temperature is in the range from 20° C. to 120° C., preferably from 30° C. to 110° C., more preferably from 40° C. to 100° C., even more preferably from 50° C. to 90° C., even more preferably from 60° C. to 80° C., even more preferably from 65° C. to 75° C. This has the advantage, on the one hand, that the temperature is low enough to minimise the formation of impurities and, on the other hand, that the temperature is high enough to remove in particular polycyclic amines efficiently.

In a preferred embodiment the washing of the synthetic crude oil stream with the first aqueous washing solution is carried out with an average washing duration of at least 0.5 minutes, preferably at least 1 minute, more preferably at least 2 minutes, even more preferably at least 5 minutes, most preferably at least 12 minutes. Providing a longer washing duration for the basic washing allows a more complete progress of hydrolysis reactions, so that neutral compounds be removed even better. In particular, it is therefore preferred if the average washing duration is between 0.5 and 180 minutes, preferably between 1 and 120 minutes, more preferably between 2 and 60 minutes, even more preferably between 5 and 30 minutes, most preferably between 12 and 20 minutes.

The average washing duration is preferably the average time period between bringing the synthetic crude oil stream into contact with the first aqueous washing solution and separating the first purified synthetic crude oil stream from the first aqueous washing solution. If the washing is carried out in a continuous process, the average washing duration preferably corresponds to the average residence time in the washing device, e.g., in a mixer-settler.

In a preferred embodiment the washing of the synthetic crude oil stream with the first aqueous washing solution is performed at a higher pressure than the washing of the first purified synthetic crude oil stream with the second aqueous washing solution. Providing a higher pressure during basic washing enables a higher temperature and thus in turn a better removal of poorly soluble wax carboxylic acids as well as neutral compounds. In contrast, in the acidic washing a lower pressure is advantageous, since in turn the formation of unwanted impurities can be reduced and since the requirements on the material are lower, which can lead to considerable cost savings.

In a preferred embodiment, at least the washing of the synthetic crude oil stream with the first aqueous washing solution is performed in a pressure vessel. Providing a pressure vessel enables washing at higher pressures and temperatures and thus a better removal of poorly soluble wax carboxylic acids as well as neutral compounds.

Preferably, the washing of the synthetic crude oil stream with the first aqueous washing solution is performed at a pressure of more than 2 bar, preferably more than 3 bar, more preferably more than 5 bar, even more preferably more than 7 bar, most preferably more than 10 bar. As mentioned, providing such a high pressure enables a high temperature and a good removal of poorly soluble wax carboxylic acids as well as neutral compounds. It is particularly preferred if the washing of the synthetic crude oil stream with the first aqueous washing solution is performed at a pressure in the range from 2 bar to 50 bar, preferably from 3 bar to 35 bar, more preferably from 5 bar to 25 bar, even more preferably from 7 bar to 20 bar, most preferably from 10 bar to 18 bar.

Preferably, the washing of the first purified synthetic crude oil stream with the second aqueous washing solution is performed at a pressure of less than 12 bar, preferably less than 7 bar, more preferably less than 6 bar, even more preferably less than 5 bar. As mentioned, providing such a lower pressure allows the use of cheaper materials. It is particularly preferred if the washing of the first purified synthetic crude oil stream with the second aqueous washing solution is performed at a pressure in the range from 1 bar to 12 bar, preferably from 1.5 bar to 7 bar, more preferably from 2 bar to 6 bar, even more preferably from 3 bar to 5 bar.

Within the scope of the invention it has proven particularly advantageous if the pH value of the first aqueous washing solution is more than 8, preferably more than 9, more preferably more than 10, even more preferably more than 11, even more preferably more than 12, most preferably more than 13. Providing such a high pH value promotes hydrolysis reactions, whereby neutral compounds can be removed particularly well. It is particularly preferred if the pH value of the first aqueous washing solution is in the range from 8 to 14, preferably from 9 to 13, more preferably from 9.5 to 12, most preferably from 10 to 11.

In a preferred embodiment, the first aqueous washing solution contains sodium hydroxide. It is particularly preferred if the concentration of sodium hydroxide is between 0.5 and 10 wt %, in particular between 1 and 5 wt %.

With regard to the washing of the first purified synthetic crude oil stream with the second aqueous washing solution, it has proven particularly advantageous if the pH value of the second aqueous washing solution is less than 6, preferably less than 5, more preferably less than 4, even more preferably less than 3, even more preferably less than 2, most preferably less than 1. This enables a particularly efficient removal of basic impurities, for example of amines and pyridines. It is particularly preferred if the pH value of the second aqueous washing solution is in the range from 0 to 6, preferably from 1 to 5, more preferably from 2 to 4, most preferably from 2.5 to 3.5.

In a preferred embodiment, the second aqueous washing solution contains sulphuric acid. Preferably, the concentration of sulphuric acid is between 0.5 and 10 wt %, in particular between 1 and 5 wt %.

It has proven advantageous if the volumetric mixing ratio between the synthetic crude oil stream and the first aqueous washing solution is from 5:1 to 1:5, preferably from 2.5:1 to 1:2.5, even more preferably from 1.5:1 to 1:1.5. Such a mixing ratio enables both a particularly efficient removal of wax carboxylic acids and hydrolysis of neutral compounds as well as a particularly efficient removal of further acidic impurities.

Advantageously, the volumetric mixing ratio between the first purified synthetic crude oil stream and the second aqueous washing solution is from 10:1 to 1:5, preferably from 5:1 to 1:2.5, even more preferably from 2.5:1 to 1:1.5. Such a mixing ratio enables a particularly efficient removal of basic impurities.

The process according to the invention can also receive further washing steps. For example, it is possible that the first purified synthetic crude oil stream undergoes further washing or purification steps before the washing with the second aqueous washing solution takes place. However, it is preferred if no further purification step is performed between the washing of the synthetic crude oil stream with the first aqueous washing solution and the washing of the first purified synthetic crude oil stream with the second aqueous washing solution, in particular no washing step, no filtration step and/or no hydrotreating step. This has the advantage, among other things, that basic products, which are formed from neutral compounds by basic hydrolysis, can be removed in the acidic washing step immediately following the basic washing step.

Preferably, the process according to the invention does not comprise any filtration steps. Avoiding filtration steps leads to a particularly simple and economical process. Filtration steps can be avoided in particular for the reason that the washing of the synthetic crude oil stream with the basic aqueous washing solution is carried out at a higher temperature. This allows wax carboxylic acids in particular to be efficiently removed, which often dissolve more poorly at lower temperatures and may require filtration if removed poorly.

The process according to the invention can also comprise a hydrotreating step for the additional removal of impurities. However, it is preferred if the process according to the invention does not comprise a hydrotreating step. Avoiding a hydrotreating step leads to a particularly simple and economical purification process. The washing steps provided according to the invention enable a particularly good removal of impurities, even if no hydrotreating step is provided.

In a particularly preferred embodiment, the process according to the invention further comprises the step of washing the second purified synthetic crude oil stream with a third aqueous washing solution at a third temperature to obtain a third purified synthetic crude oil stream. Providing such a further washing step enables a particularly thorough removal of impurities, which may still be present after the basic and the acidic washing steps.

In this context, it is particularly preferred if the pH value of the third aqueous washing solution is in the range from 3 to 13, preferably from 4 to 12, more preferably from 5 to 11, even more preferably from 6 to 10, even more preferably from 6.5 to 9, most preferably from 7 to 8. A pH value in this range is particularly effective for the removal of small polar neutral molecules as well as of inorganic and organic salts. It is particularly advantageous if the third aqueous washing solution is basic or substantially neutral, in particular substantially neutral.

In a preferred embodiment, the third aqueous washing solution contains neutral amines. This has the advantage that the following plants can be protected even better.

In a preferred embodiment, the third temperature is lower than the first temperature. This enables the process to be carried out efficiently and economically, since the crude oil stream does not have to be heated before washing with the third aqueous washing solution.

Preferably, the third temperature is less than 120° C., preferably less than 110° C., more preferably less than 100° C., even more preferably less than 90° C., even more preferably less than 80° C., most preferably less than 75° C. It is particularly preferred if the third temperature is in the range from 20° C. to 120° C., preferably from 30° C. to 110° C., more preferably from 40° C. to 100° C., even more preferably from 50° C. to 90° C., even more preferably from 60° C. to 80° C., even more preferably from 65° C. to 75° C.

It has proven advantageous if the washing of the synthetic crude oil stream with the first aqueous washing solution is performed at a higher pressure than the washing of the second purified synthetic crude oil stream with the third aqueous washing solution. Providing a higher pressure during the basic washing enables a higher temperature and thus a more thorough removal of poorly soluble wax carboxylic acids as well as neutral compounds. However, when washing with the third aqueous washing solution, a lower pressure is advantageous, as this reduces the requirements on the material used, which can lead to considerable cost savings.

In a preferred embodiment, the washing of the second purified synthetic crude oil stream with the third aqueous washing solution is performed at a pressure of less than 12 bar, preferably less than 10 bar, more preferably less than 8 bar, even more preferably less than 7 bar. A pressure in the range from 1 bar to 12 bar, preferably from 1.5 bar to 10 bar, more preferably from 2 bar to 8 bar, even more preferably from 3 bar to 7 bar, is particularly preferred.

It has proven advantageous if the volumetric mixing ratio between the second purified synthetic crude oil stream and the third aqueous washing solution is from 10:1 to 1:5, preferably from 5:1 to 1:2.5, even more preferably from 2.5:1 to 1:1.5. Such a mixing ratio enables a particularly efficient removal of remaining impurities.

In connection with the invention, it is preferred if the process for purifying a synthetic crude oil stream is a continuous process. Compared to a batch process, this has the advantage that higher productivity and shorter downtimes are achieved. Preferably, the steps of washing the synthetic crude oil stream with the first aqueous washing solution, washing the first purified synthetic crude oil stream with the second aqueous washing solution, and, if provided, washing the second purified synthetic crude oil stream with the third aqueous washing solution are therefore part of a continuous process. It is also preferable if the process according to the invention for producing synthetic crude oil is a continuous process, i.e. if the production of the synthetic crude oil stream, preferably by depolymerisation of plastic material, is also part of the continuous process. Providing a continuous process has, in particular, the advantage that heating of the synthetic crude oil stream can be avoided, since the synthetic crude oil stream obtained from the production process can be washed with the first aqueous washing solution directly or after cooling to the first temperature, or the first purified synthetic crude oil stream can be washed with the second aqueous washing solution after cooling from the first temperature to the second temperature.

Typically, washing a crude oil stream with an aqueous washing solution comprises mixing the crude oil stream with the washing solution, followed by separating the purified crude oil stream from the aqueous washing solution.

Preferably, the washing steps of the process according to the invention are carried out in a mechanical mixer, in a static mixer and/or in a mixer-settler. It has proven to be particularly advantageous if the washing steps of the process according to the invention are each carried out in a mixer-settler. Typically, mixer-settlers comprise a continuously operated mixing zone and a continuously operated settling zone and therefore allow the synthetic crude oil stream to be mixed with the respective aqueous washing solution, as well as the subsequent settling process for separating the phases and separating the purified synthetic crude oil stream in a continuous process.

In connection with the invention, a “synthetic crude oil stream” preferably means a stream of matter containing a synthetic crude oil or a fraction of a synthetic crude oil. Preferably, the synthetic crude oil stream consists of synthetic crude oil or a fraction thereof. Within the scope of the invention, it is particularly preferred if the synthetic crude oil stream comprises, in particular consists of, a pyrolysis oil or a fraction thereof. Preferably, the pyrolysis oil is a pyrolysis oil obtained from biomass, in particular wood, and/or plastic. The process according to the invention has proven to be particularly suitable if the synthetic crude oil stream is a hydrocarbon mixture obtained from the depolymerisation of biomass or plastic material, in particular plastic material. Preferably, the synthetic crude oil stream is therefore a plastic pyrolysate or a fraction thereof, or a biomass pyrolysate, in particular wood pyrolysate, or a fraction thereof. However, the process according to the invention is also well suited for other synthetic crude oils and fractions thereof. In further preferred embodiments, the synthetic crude oil stream therefore comprises, preferably consists of, shale oil or upgraded bitumen.

In connection with the process according to the invention for producing synthetic crude oil, it is therefore preferred if the synthetic crude oil stream is produced by depolymerisation of plastic material, preferably plastic waste. The person skilled in the art is familiar with the production of a synthetic crude oil stream by depolymerisation of plastic material. Such processes are known, for example, from WO 2012/149590 A1 and U.S. Pat. No. 6,060,631 A.

Synthetic crude oil obtained from plastic material typically contains a number of different impurities, in particular also wax carboxylic acid, polycyclic amines and neutral compounds, which can be removed particularly well by the process according to the invention. This applies in particular to plastic waste, which usually comprises mixtures of different plastics. In addition, plastic material typically contains additives that can lead to impurities in the form of organic phosphates or phosphonates. Such phosphates or phosphonates can be hydrolysed under basic conditions in the process according to the invention and can thus be removed particularly efficiently.

In a preferred embodiment, the plastic material comprises polyethylene (PE), polypropylene (PP), polystyrene (PS), polyvinyl chloride (PVC), polyethylene terephthalate (PET), polyamide (PA), styrene-acrylonitrile (SAN), and/or acrylonitrile-butadiene-styrene (ABS). The process according to the invention has proven to be particularly suitable for removing impurities resulting from the plastic materials mentioned.

It is particularly preferred if the plastic material contains PVC. This typically leads to impurities in the form of organochlorine compounds in the crude oil stream obtained from the plastic material. Organochlorine compounds be removed particularly well by the basic hydrolysis in the course of washing with the first aqueous washing solution.

It is also particularly preferred if the plastic material contains PET. This typically leads to impurities in the form of ester compounds in the crude oil stream obtained from the plastic material, which can also be removed particularly well by basic hydrolysis in the course of washing with the first aqueous washing solution.

In particular, it is preferred if the plastic material comprises PA, SAN, and/or ABS. These plastic materials typically lead to impurities in the form of amides and nitriles. In the course of the process according to the invention, these compounds can also be hydrolysed in the course of washing with the first aqueous washing solution. The basic compounds formed from the basic hydrolysis, in particular amines, can be efficiently removed in the subsequent washing with the acidic aqueous washing solution. PA, SAN and ABS can also serve as nitrogen sources and contribute to the increased formation of polycyclic amines through rearrangement reactions, condensation reaction and/or radical reactions, for example with PE, PP and PS. These can be efficiently removed by washing with the acidic aqueous washing solution provided according to the invention.

All parameters mentioned herein refer, unless otherwise indicated, to SATP conditions according to IUPAC (“Standard Ambient Temperature and Pressure”), in particular to a temperature of 25° C. and a pressure of 101, 300 Pa.

All percentages (%) herein refer, unless otherwise indicated, to percent by weight.

Unless otherwise indicated, all mixing ratios specified herein refer to volumetric mixing ratios, i.e. to volume ratios (volume:volume).

The temperatures specified herein for the washing steps preferably refer in each case to the temperature of the mixture of crude oil stream and aqueous washing solution immediately after mixing and before phase separation.

The present invention is illustrated by the following figure, to which, of course, it is not limited.

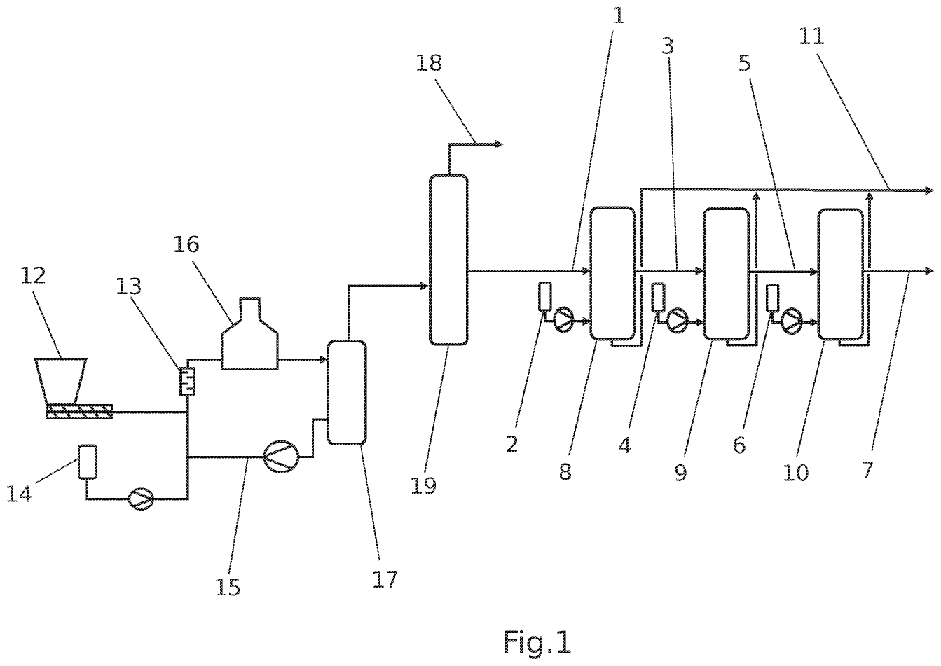

FIG. 1 shows a process flow diagram of a preferred embodiment of the process according to the invention for producing synthetic crude oil.

In the embodiment shown in FIG. 1, the synthetic crude oil stream 1 is obtained by depolymerisation of plastic material. The plastic material is compacted, degassed and melted in an extruder 12. The plastic melt exiting the extruder 12 is mixed in a static mixer 13 with an external solvent 14, preferably heavy fuel oil, and/or with already cracked plastic material, which is recirculated as recycling stream 15, in order to reduce the viscosity of the plastic melt. The resulting mixture is introduced into a depolymerisation reactor 16, in which the plastic material is depolymerised, preferably at a temperature between 400° C. and 440° C. Cracked plastic material is obtained as the top product of a column 17. After separation of a gas stream 18 in a further column 19, the synthetic crude oil stream 1 is obtained.

In the embodiment shown, the synthetic crude oil stream 1 is mixed with a first aqueous washing solution 2 in a mixing zone of a first mixer-settler 8, preferably in a volumetric mixing ratio of 1:1. The first aqueous washing solution 2 is preferably sodium hydroxide solution with a pH value between 9 and 12. The mixture of the synthetic crude oil stream 1 and the first aqueous washing solution 2 preferably has a temperature of at least 95° C. Since the synthetic crude oil stream 1 is fed directly from the manufacturing process into the mixer-settler 8, no heating is required to reach this temperature. In particular, the high temperature improves the water solubility of wax carboxylic acids, which enter the aqueous phase in deprotonated form due to the basic pH value. In addition, the high temperature favours the hydrolysis of impurities in the form of neutral compounds. Acidic hydrolysis products, e.g. carboxylic acids, are deprotonated due to the basic pH value and also pass into the aqueous phase as charged compounds. As a result, the purified oil phase is separated from the aqueous phase in a settling zone of the mixer-settler 8. The average residence time in the first mixer-settler 8 is preferably between 5 and 30 minutes. The aqueous phase is removed as part of the wastewater stream 11 and the oil phase is separated as the first purified synthetic crude oil stream 3.

The first purified synthetic crude oil stream 3 thus obtained is then mixed with a second aqueous washing solution 4 in a second mixer-settler 9. The second aqueous washing solution 4 is preferably aqueous sulphuric acid with a pH value between 0 and 5. The temperature of the mixture of the first purified synthetic crude oil stream 3 and the second aqueous washing solution 4 is lower than the temperature of the mixture in the first washing step, preferably less than 90° C. The lower temperature in the second washing step reduces the formation of additional impurities and increases the product yield. In addition, the requirements for the material of the second mixer-settler 9 are lower; in particular, there is no need for expensive materials and coatings. In addition, the second washing can be carried out at a lower pressure, which in turn leads to lower requirements on the material used. In particular, basic impurities such as amines or pyridines are protonated by washing with the acidic washing solution and thus pass into the aqueous phase as charged compounds. In addition, remaining neutral compounds can also be hydrolysed under acidic conditions. Subsequently, the purified oil phase is again separated from the aqueous phase in a settling zone of the mixer-settler 9, the aqueous phase is removed via the wastewater stream 11, and a second purified synthetic crude oil stream 5 is obtained from the oil phase.

In the embodiment shown, the second purified synthetic crude oil stream 5 is washed with a third aqueous washing solution 6 in a third mixer-settler 10. The third aqueous washing solution 6 is preferably a neutral washing solution, preferably essentially water. The temperature in this washing step preferably corresponds to the temperature of the second washing step or is below it. In this washing step, impurities are removed, some of which may still be present after the first two washing steps, for example products of acidic hydrolysis, small polar neutral molecules and inorganic and organic salts. The neutral washing also increases the safety with regard to the further use of the third purified synthetic crude oil stream 7 obtained therefrom. After washing, the aqueous phase is again removed as part of the wastewater stream 11, and the third purified synthetic crude oil stream 7 is obtained from the oil phase.

1. A process for purifying a synthetic crude oil stream, comprising:
providing a synthetic crude oil stream;
washing the synthetic crude oil stream with a first aqueous washing solution at a first temperature in order to obtain a first purified synthetic crude oil stream; and
washing the first purified synthetic crude oil stream with a second aqueous washing solution at a second temperature in order to obtain a second purified synthetic crude oil stream,
wherein the first aqueous washing solution is basic, the second aqueous washing solution is acidic, and the second temperature is lower than the first temperature, and wherein the first temperature is more than 100° C.

2. The process according to claim 1, wherein the first temperature is more than 105° C.

3. The process according to claim 1, wherein the washing of the synthetic crude oil stream with the first aqueous washing solution is carried out with an average washing duration of at least 0.5 minutes.

4. The process according to claim 1, wherein the washing of the synthetic crude oil stream with the first aqueous washing solution is performed at a higher pressure than the washing of the first purified synthetic crude oil stream with the second aqueous washing solution.

5. The process according to claim 1, wherein the pH value of the first aqueous washing solution is more than 8.

6. The process according to claim 1, wherein the pH value of the second aqueous washing solution is less than 6.

7. The process according to claim 1, wherein the volumetric mixing ratio between the synthetic crude oil stream and the first aqueous washing solution is from 5:1 to 1:5.

8. The process according to claim 1, wherein between the washing of the synthetic crude oil stream with the first aqueous washing solution and the washing of the first purified synthetic crude oil stream with the second aqueous washing solution no further washing step is performed.

9. The process according to claim 1 further comprising:
washing the second purified synthetic crude oil stream with a third aqueous washing solution at a third temperature in order to obtain a third purified synthetic crude oil stream.

10. The process according to claim 9, wherein the pH value of the third aqueous washing solution is in the range from 3 to 13.

11. The process according to claim 9, wherein the third temperature is lower than the first temperature.

12. The process according to claim 9, wherein the washing of the synthetic crude oil stream with the first aqueous washing solution is performed at a higher pressure than the washing of the second purified synthetic crude oil stream with the third aqueous washing solution.

13. The process according to claim 9, wherein the volumetric mixing ratio between the second purified synthetic crude oil stream and the third aqueous washing solution is from 10:1 to 1:5.

14. A process for producing synthetic crude oil, comprising:
producing a synthetic crude oil stream, preferably by depolymerisation of plastic material, in particular plastic waste; and
purifying the synthetic crude oil stream according to the process of claim 1.

15. The process according to claim 14, wherein the plastic material comprises polyethylene (PE), polypropylene (PP), polystyrene (PS), polyvinyl chloride (PVC), polyethylene terephthalate (PET), polyamide (PA), styrene-acrylonitrile (SAN), and/or acrylonitrile-butadiene-styrene (ABS).
